(19) United States
(12) Patent Application Publication
(10) Pub. No.: US 2007/0056501 A1
(43) Pub. Date: Mar. 15, 2007

(54) Adjustable decorative bookmark

(76) Inventor: Joni Chapa, Salt Lake City, UT (US)

Correspondence Address: HOLME ROBERTS & OWEN, LLP, 299 SOUTH MAIN, SUITE 1800, SALT LAKE CITY, UT, 84111, US

(21) Appl. No.: 11/224,660

(22) Filed: Sep. 12, 2005

(51) Int. Cl. B42D 9/00

(52) U.S. Cl. 116/234

(57) ABSTRACT

A system and method for an adjustable bookmark for marking a page in a book having a plurality of pages. The system and method provides a first portion that is secured to a section of the book such as the cover, spine or any number of pages while a second portion is secured to a marking means that marks a page in the book.

### BACKGROUND OF THE INVENTION

1. The Field of the Invention

The present invention relates to a bookmark and method for marking a page in a book with an adjustable decorative bookmark.

2. The Relevant Technology

Typically, a reader does not finish a book in a single sitting. Thus a reader looks for a way to mark the location in the book where the reader stopped with an expectation of continuing from that point at a later time. A bookmark is simply a placeholder in a book so that the reader may easily return to the last page the reader read. Bookmarks are used to mark all sorts of books from textbooks to works of fiction.

In their present form, typical bookmarks easily fall out of the book, which is highly frustrating to the reader who has to try to recover the reader's place in the book. In addition, bookmarks are easily lost or misplaced.

While some books (like books used at religious ceremonies) have ribbon book marks affixed to the spine, most books have no associated structure to provide for marking. It would therefore be desirable to provide an adjustable bookmark that adjusts to a variety of different shapes of books that is not easily lost, misplaced or knocked out of place.

### SUMMARY OF THE INVENTION

The present invention is an adjustable decorative bookmark for temporarily or permanently marking a page in a book. In various exemplary embodiments of the present invention, a first portion of the bookmark is secured to a section of the book such as the cover, spine or any number of pages while a second portion of the bookmark is secured to a marking means that marks a page in the book. The first portion of the bookmark is adjustable, so the bookmark is transferable among any number of books having different shapes and sizes. The adjustable bookmark may also remain with one particular book that is used and marked repeatedly, such as a textbook for a college professor or a bible for a churchgoer.

A system and method for an adjustable decorative bookmark for temporarily marking a page in a book is provided. The bookmark has a line having a loop portion having a first leg and a second leg. The loop portion is sufficiently sized to extend around a portion of a book having pages. The line also has a marking section attached to said loop portion that extends away from the loop portion. The marking section is sized in length for positioning the distal end between two pages of the book at the same time the loop portion is installed on the portion of the book.

A retaining device is provided for holding the first leg and the second leg relative to each other so as to form the loop portion. The retaining device is configured to allow relative movement of at least the first leg relative to the second leg. A marking means is secured to the distal end of the marking section for marking a page in the book.

In one embodiment, the retaining device is configured to provide a tension in the loop portion. In one particular embodiment, the retaining device is attached at a selected position to removably secure the loop portion to a section of a book. Preferably, the fastener is configured to be slightly smaller than two times the diameter of the line so that at least one section of the line moves relative to the other section of line and both sections of line engage the retaining device using a frictional force.

In yet another embodiment, the retaining device is a securing member having an aperture disposed therein for receiving a first leg and second leg of the loop section, the aperture is sized slightly smaller than two times the diameter of the line, the aperture is sized to frictionally engage the first and second legs of the loop section at a selected position.

In still another embodiment, the loop section is configured to engage a spine, a cover, or a plurality of pages of the book.

In another embodiment, a bookmark for use with a book having at least a bookmark mounting portion and at least two pages is described. The bookmark has a length of flexible material formed into a loop. The length of flexible material has a first end with a first leg extending therefrom and a second end having a second leg extending therefrom. The bookmark is provided with an adjuster for positioning about the first leg and the second leg and sized for frictional movement of at least one of said first leg and said second leg through said adjuster. Accordingly, the adjuster moves the loop between a first position sized to snuggly engage the bookmark mounting portion and a second position, larger than the first position, for disengaging said loop from the bookmark mounting portion. The bookmark also has a marking means. The marking means has a lead formed from one of either the first leg or the second leg that extends away from the loop and the adjuster. The lead is sized in length to position one of either the first end or the second end of the first leg or the second leg between two pages. The marking means also has a marker attached to at least one of either the first end or the second end for marking. The marking means is attached to one of the first end and the second end of the length of flexible material.

### BRIEF DESCRIPTION OF THE DRAWINGS

To further clarify the above and other advantages and features of the present invention, a more particular description of the invention will be rendered by reference to specific embodiments thereof which are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIG. 1 illustrates one embodiment of an adjustable decorative bookmark in accordance with the present invention;

FIG. 2 illustrates another embodiment of an adjustable decorative bookmark;

FIG. 2A illustrates another embodiment of an adjustable decorative bookmark;

FIG. 3 illustrates a front perspective view of a securing member for use with an adjustable decorative bookmark;

FIG. 4 illustrates a top view of the securing member of FIG. 3;

FIG. 5 illustrates a front perspective view of another embodiment of a securing member for use with an adjustable decorative bookmark;

FIG. 6 illustrates a top view of the securing member of FIG. 5;

FIG. 7 illustrates an embodiment of a marking means;

FIG. 8 illustrates another embodiment of a marking means;

FIG. 9 illustrates still another embodiment of a marking means;

FIG. 10 illustrates yet another embodiment of a marking means;

FIG. 11 illustrates another embodiment of a marking means;

FIG. 12 illustrates yet another embodiment of a marking means;

FIG. 13 illustrates still another embodiment of a marking means;

FIG. 14 illustrates one embodiment of an adjustable decorative bookmark in operation;

FIG. 15 illustrates another embodiment of an adjustable decorative bookmark in operation;

FIG. 16 illustrates still another embodiment of an adjustable decorative bookmark in operation;

FIG. 17 illustrates yet another embodiment of an adjustable decorative bookmark in operation; and

FIG. 18 illustrates the embodiment of an adjustable decorative bookmark illustrated in FIG. 2A in operation.

### DETAILED DESCRIPTION OF THE PREFERRED EMBODIMENTS

Reference will now be made in detail to the preferred and alternate embodiments of the present invention, examples of which are illustrated in the accompanying drawings.

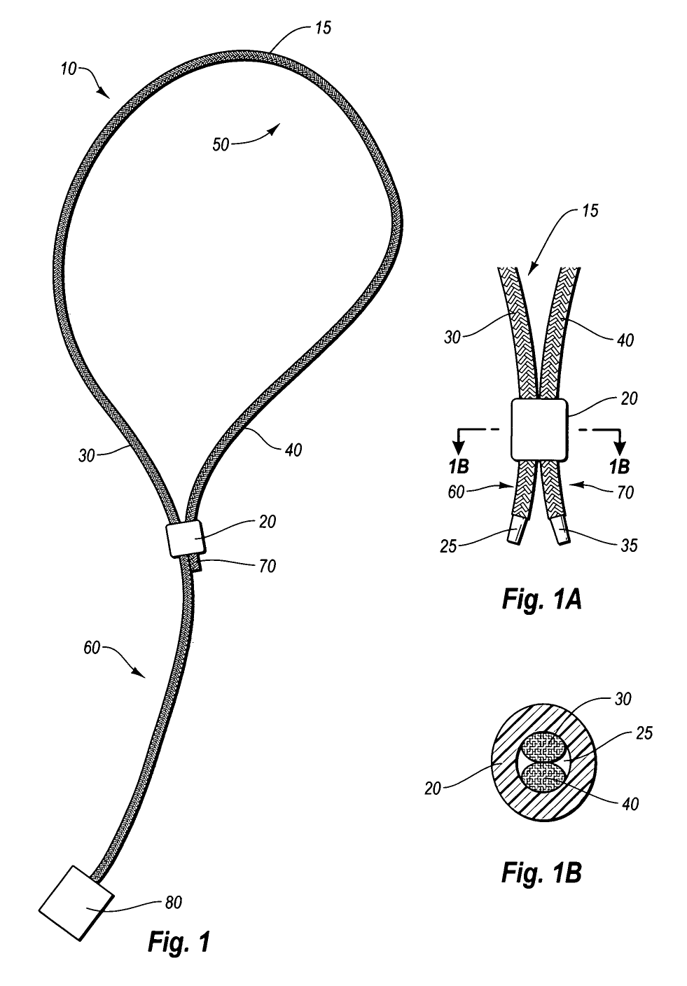

The present invention is an adjustable decorative book marking device, which is shown and identified in FIG. 1 by the reference numeral 10. As shown in FIG. 1, bookmark device 10 generally comprises a line 15, a securing member or retaining device 20 and a marking means 80. Both ends of line 15 are fed through securing member 20 to form an adjustable loop portion 50 for attaching to a section of a book. Adjustable loop portion 50 is formed by retaining device 20 holding the first leg 30 and the second leg 40 of line 15 relative to one another.

FIG. 1A illustrates one particular embodiment of passing line 15 through securing member 20 prior to connecting a marking means 80 to the distal end of line section 60 to form loop portion 50. In the embodiment of FIG. 1A, a first end 25 of line 15 is fed through an aperture in securing member 20. Then, a second end 35 of line 15 is also fed through the same aperture in securing member 20. A loop section 50 is formed having a first leg section 30 and a second leg section 40. Either first end 25 or second end 35 or both may be moved relative to securing member 20, thereby changing the length of a first line section 60 or second line section 70. Either first line section 60 or second line section 70 or both may be used as a marking section to attach marking means 80 thereto.

Referring now to FIG. 1B, a cross sectional view of securing member 20 having a first leg 30 and second leg 40 contained within the diameter of aperture 25 is shown. In operation, aperture 25 of securing member 20 has a diameter slightly smaller than two times the diameter of line 15. Choosing the size of the diameter of aperture 25 according to the diameter of line 15 allows the securing member 20 to hold the first leg section 30 relative to the second leg section, while also allowing movement of at least one of the legs of the line 15 relative to the second leg of the line. The movement of at least one of the legs allows for sizing of loop section 50 to fit a section of a book, such as a cover, spine or a plurality of pages. Line 15 is preferably made of a material such as leather, nylon, polyester, polypropylene, cotton, yarn, natural fiber or synthetic material. However, numerous useful materials and cords are known and any and all varieties are intended to be used herewith.

Preferably, adjustable loop section 50 is sized to fit around the cover of a large book. Since loop section 50 is adjustable, bookmark 10 will fit any book smaller than the largest book it is sized to accommodate. For example, the Encyclopedia Britannica World Atlas has a cover dimension of 14 inches by 10 inches. Typically, the first leg 30 of loop section 50 will rest against the face of the cover and the second leg 40 of loop section 40 will rest against the back of the cover. In the World Atlas example, the total length of loop section 50, including both first leg 30 and second leg 40, is at its maximum, approximately 28 inches. Since the loop section 50 is adjustable, adjustable bookmark 10 can accommodate a wide range of smaller size covers as well. It may be appreciated that the line 15 may be sized according to the books that the adjustable bookmark is intended to accommodate.

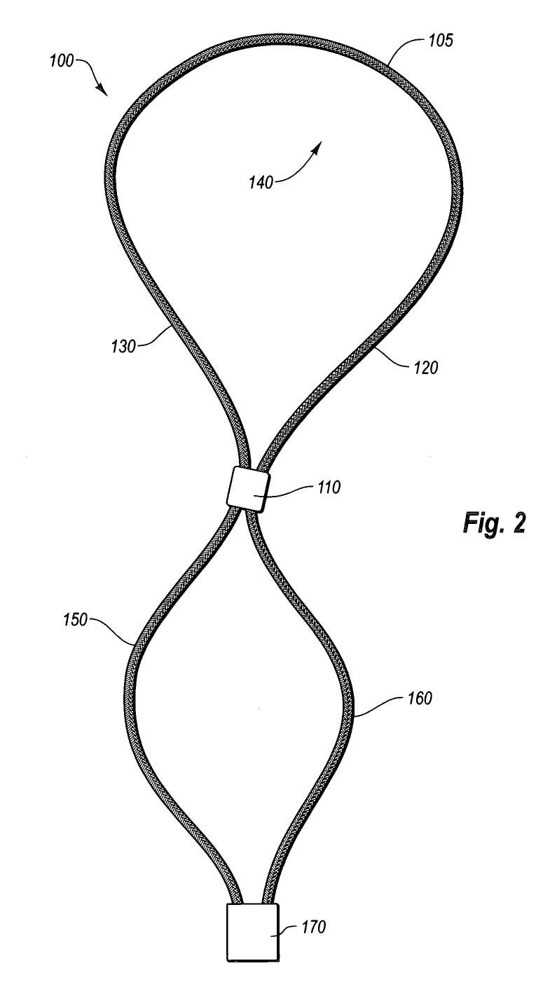

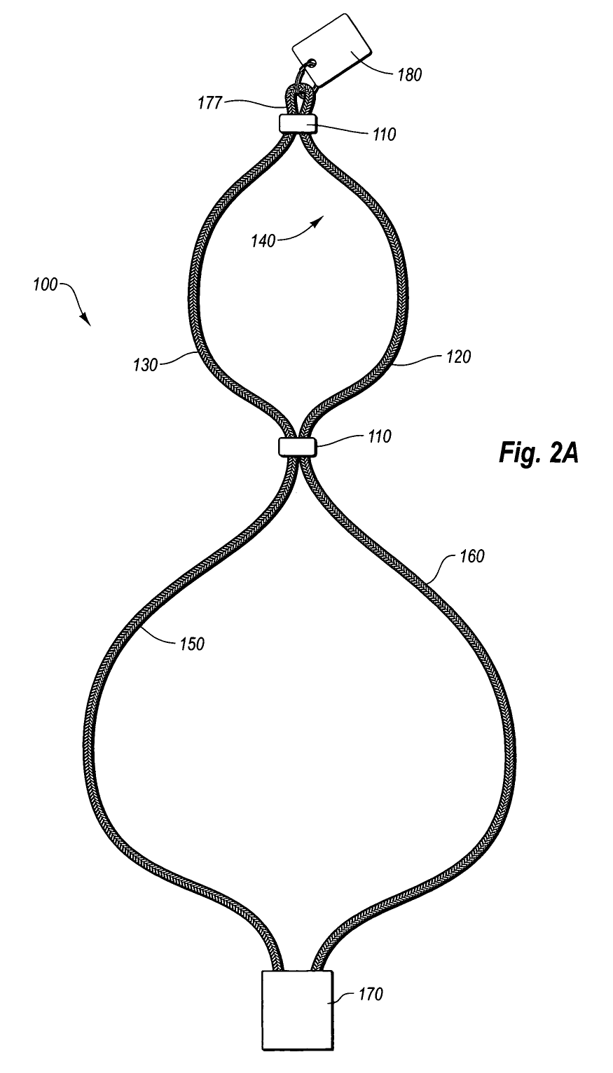

FIG. 2 illustrates a second embodiment of the adjustable decorative bookmark device 100 in accordance with the present invention. Bookmark 100 is generally formed by line 105, securing device 110 and marking means 170. The ends of line 105 are fed through securing means 110 to form a loop section 140 for placing over a section of a book, such as the cover, the spine or a plurality of pages. First leg 120 and second leg 130 are held relative to one another by retaining member 110. Retaining member 110 also allows movement of either or both securing leg 120 and second leg 130 relative to securing member 110 to increase or decrease the lengths of line section 150 and line section 160. Such movement also increases or decreases the size of loop section 140.

In the illustrated embodiment of FIG. 2, the distill end of line section 150 and the distal end of line section 160 are both connected to marking means 170. In operation, loop section 140 may be placed around a section of the book and a force may be applied to marking means 170 to lengthen both line section 150 and line section 160, thereby tightening loop section 140 around a section of a book.

FIG. 2A shows another embodiment of the adjustable decorative bookmark 100 in accordance with another aspect of the invention. Adjustable decorative bookmark 100 has a second retaining member 175 for receiving first leg 120 and second leg 130 of loop section 140. Loop retaining means 180 is fed through a loop portion 177 of loop 140 that extends through second retaining member 175. Second retaining member 175 is used to protect the point of contact with a book as well as establish a more secure contact point with the book portion.

In operation, loop 140 is passed through an aperture (not shown) in second retaining member 175, thereby forming a smaller loop section 177. A loop retaining means 180 keeps loop section 177 in place, such that once loop section 177 is secured by loop retaining means 180, it will not pass back through second retaining member 175. The loop retaining means 180 may be, for example, a smaller version of the decorative marking means described hereinafter. The second retaining member 175 forms the bottom portion of a loop section that contacts a book section, such as the cover, spine or a plurality of pages.

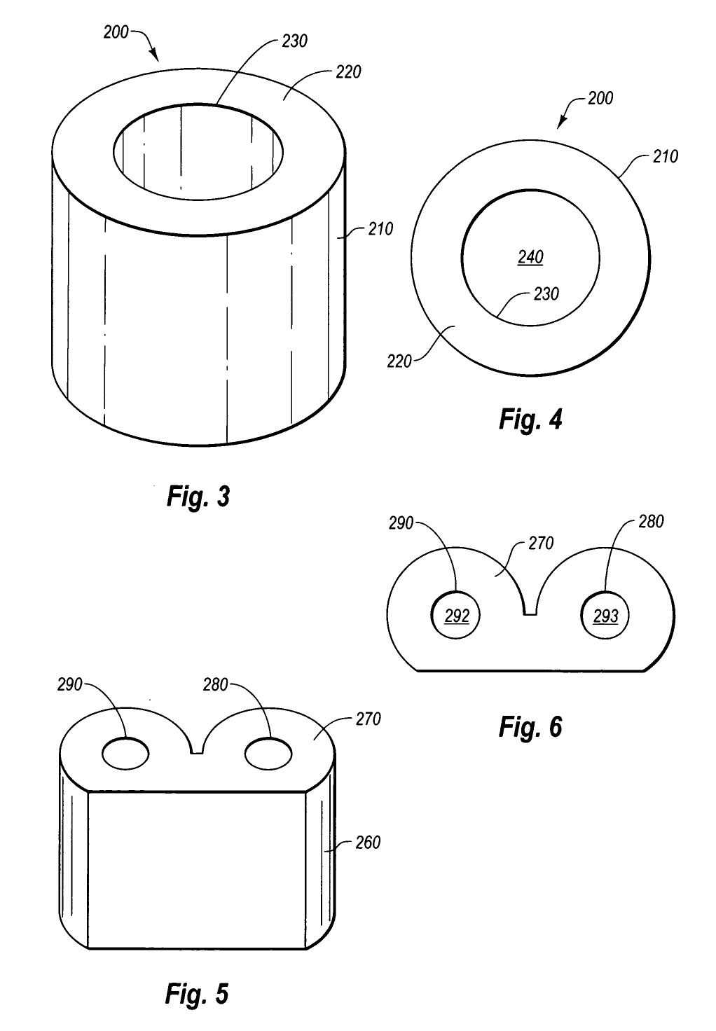

FIGS. 3 and 4 are a front perspective view and a top view respectively of one embodiment of a securing member 200. Securing member 200 has an outer radius 210 and an inner radius 230. An aperture 240 is formed, for example, by boring a hole through top surface 220 through securing member 200 and exiting out the bottom surface (not shown). As shown, aperture 240 is circular in shape. However, any shape may be used that provides tension on the line, such as oval, square, semi-circular, triangular to name a few. Typically, aperture 240 is sized slightly smaller than two times the diameter of the line for materials such as cotton, yarn, or other natural fibers to name a few. However, depending upon the material used for the line, aperture 240 may be sized equal to two times the diameter of the line for certain materials such as leather and some synthetic fibers. Further, aperture 240 may be sized and slightly larger than two times the diameter of the line for some materials, such as nylon and polypropylene.

In operation, two ends of a line are passed through aperture 240 to form a loop section that is sized for securing to a book section, such as the cover, spine or a plurality of pages. The sections of the line that pass through aperture are held against the inner radius 220 of aperture 240 by a coefficient of friction. The coefficient of friction depends upon the friction or texture of the line itself, its elasticity, creep, and the area of contact. For the adjustable bookmark to operate as intended, the coefficient of friction must be sufficient to hold the two sections of the line in a secure position relative to one another when the loop section is tightened on a section of the book, while at the same time allowing movement of either one or both sections of the line within the aperture to perform the tightening action.

FIGS. 5 and 6 are a front perspective view and top view respectively of a second embodiment of a securing member 250. Securing member 250 has two holes bored through top surface 270 through securing member 250 and exiting the bottom surface (not shown). The diameter of the bored holes 280, 290 form apertures 292, 293 respectively. Apertures 292, 293 are sized to be slightly smaller than the radius of a line for certain materials, such as cotton, yarn, cord, or other natural fibers. Apertures 292, 293 may be sized equal to the diameter of the line for certain materials such as leather or some synthetic materials. Apertures 292, 293 may be sized slightly larger than the diameter of the line for some materials such as nylon and polypropylene.

In operation, a first end of a line is passed through aperture 292 of securing member 250 and a second end of a line is passed through aperture 293. The sections of the line that pass through aperture 292 and 293 are held against the inner radius 290 and 280 respectively by a coefficient of friction. As described above with respect to securing member 200, the coefficient of friction must be sufficient to hold the two sections of the line in a secure position relative to the inner radius 280, 290 of aperture 293 and 292 respectively when the loop section is tightened on a section of the book, while at the same time allowing movement of either one or both sections of the line within apertures 292, 293 to perform a tightening action on the loop section—i.e. reducing the size of the loop section to secure the adjustable bookmark to the book section.

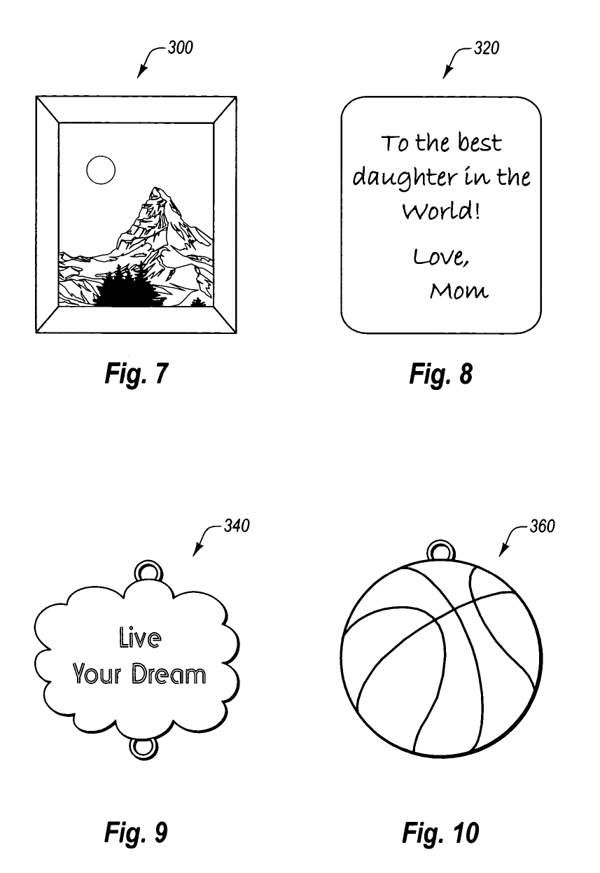

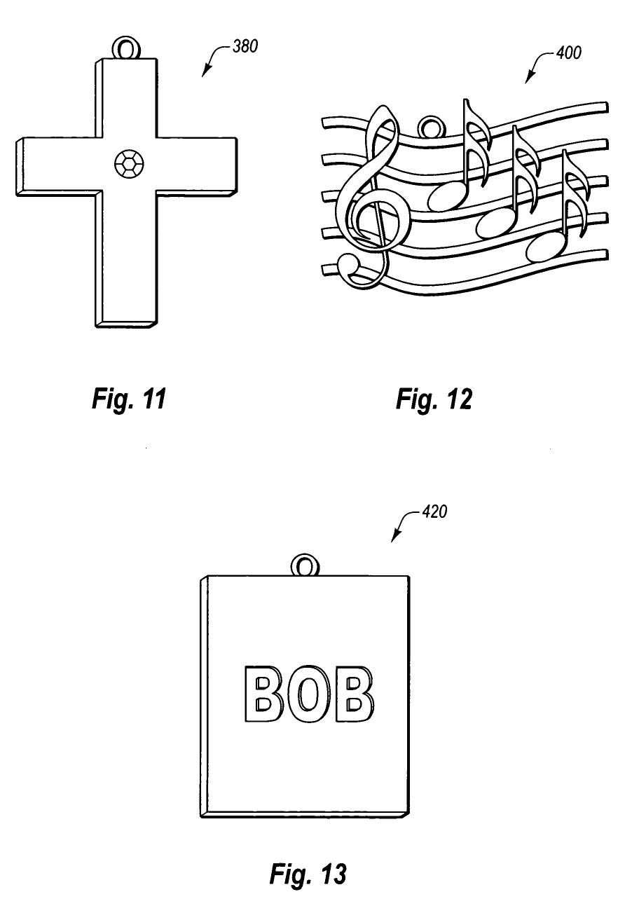

FIGS. 7-13 illustrate several different embodiments of a marking means for marking pages in a book. The marking means illustrated in FIGS. 7-13 are meant to be illustrative and are in no way to be construed as an exhaustive list of the number of possible marking means available. In addition, the marking means may be manufactured using a metal, wood, plastic, cardboard, paper or any other synthetic or natural fiber material. FIG. 7 shows a marking means 300 that is formed into a picture frame. FIG. 8 illustrates a marking means that is engraveable. FIG. 9 shows a marking means that is formed into a charm. FIG. 10 depicts a marking means that is in the shape of an athletic device, such as a basketball. FIG. 11 illustrates a marking means in the form of a cross with a jewel in the center thereof. FIG. 12 shows a marking means in the form of a clef and a plurality of musical notes. FIG. 13 illustrates a marking means that has a name thereon.

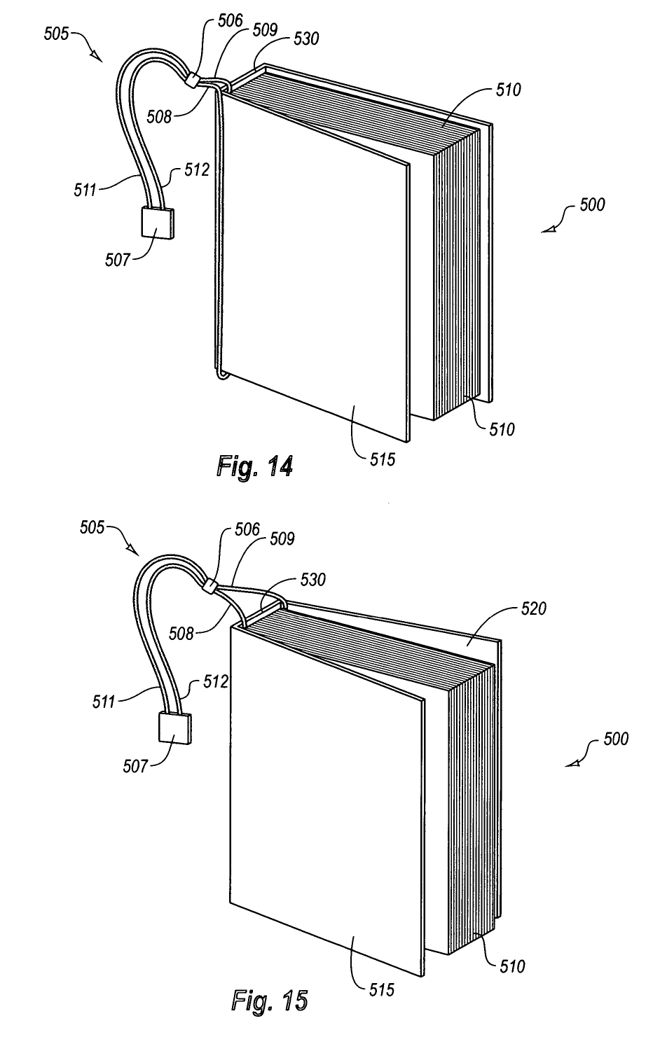

FIGS. 14-17 illustrate the method of operation and use of the bookmark device of the present invention. In FIG. 14, the loop portion of the adjustable bookmark 505 is placed around the cover 515 of the book 500. A first leg 508 of the loop portion rests against the front of cover 515 and a second leg 509 of the loop portion rests against the back of cover 515. Securing member 506 is tightened—i.e. securing member 506 is moved relative to the first leg 508 and second leg 509 such that marking sections 511, 512 increase in length and the loop portion becomes smaller until securing member 506 rests snuggly against cover 515. The marking means 507 attached to the distil end of marking sections 511, 512 is in position to mark a page in the plurality of pages 510.

Referring now to FIG. 15, the loop section of adjustable bookmark 505 is placed around a plurality of pages 510 of book 500. A first leg 509 of the loop portion is positioned between the back side of back cover 520 and one of a plurality of pages 500. A second leg 508 of the loop portion is placed between the back side of front cover 515 and one of a plurality of pages 510. Securing member 506 is tightened against the book—i.e. securing member 506 is moved relative to the first leg 508 and second leg 509 such that marking sections 511, 512 increase in length and the loop portion decreases in size until securing member 506 rests snuggly against or in close proximity to the plurality of pages 510.

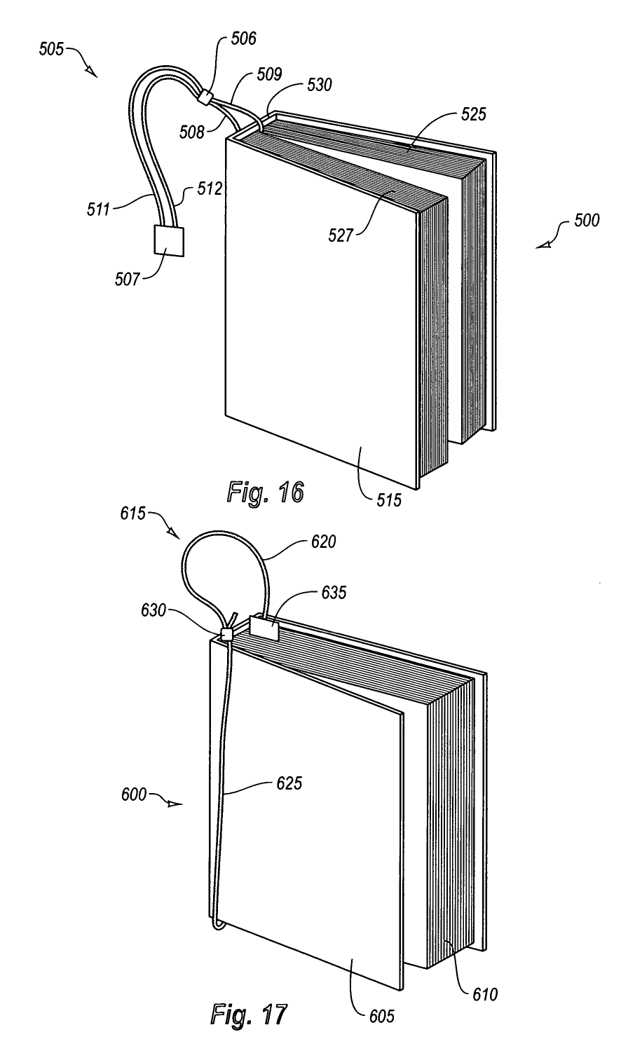

Referring to FIG. 16, the loop section of adjustable bookmark 505 is placed around the spine 530 of book 500. A first leg 509 of the loop portion is positioned between the a first plurality of pages 525 and a second plurality of pages 527 adjacent to the spine 530. A second leg 508 of the loop portion is placed on the face of spine 530. Securing member 506 is tightened against the book—i.e. securing member 506 is moved relative to the first leg 508 and second leg 509 such that marking sections 511, 512 increase in length and the loop portion decreases in size until securing member 506 rests snuggly against or in close proximity to the spine 530 of book 500.

FIG. 17 illustrates an adjustable bookmark 615 having a marking means 635 inserted between two pages of a plurality of pages 610 of book 600. As shown, the loop portion 625 is placed around the cover 605 of book 600. The retaining device 630 is tightened—i.e. retaining device 630 is held against the cover 605 of book 600 and a tensional force is applied to the marking section 620 such that the length of marking section 620 increases and the size of loop portion 625 decreases. The tensional force applied to marking section 620 is stopped when the loop section 625 is snuggly fit to the front and the back of front cover 605. Marking means 635 may then be placed between two pages of the plurality of pages 610.

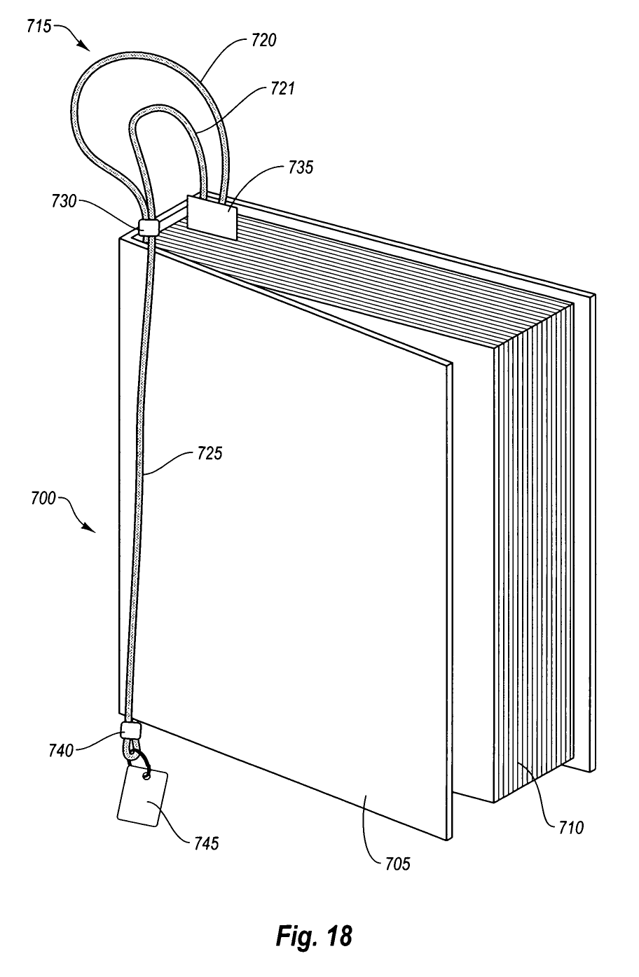

FIG. 18 illustrates an adjustable bookmark 715 having a marking means 735 inserted between two pages of a plurality of pages 710 of book 700. Adjustable bookmark 725 is similar to the adjustable bookmark illustrated and described with respect to FIG. 2A. As shown, the lower loop portion 725 is placed around the cover 705 of book 700. Prior to positioning the lower loop portion 725 over cover 705, lower loop portion 725 is fed through a second retaining device 740, thereby creating a smaller loop on the other side of second retaining device 740. Second retaining device 740 is held in place on loop portion 725 by fastening a retaining member 745 to the loop created on the back side of second retaining device 740.

In operation, the retaining device 730 is tightened—i.e. retaining device 730 is held against the top portion of the cover 705 of book 700, while second retaining device 740 is held against the bottom portion of cover 705. A tensional force is applied to the marking section 720, 721 such that the length of marking sections 720, 721 increase and the size of loop portion 725 decreases. The tensional force applied to marking section 720 is stopped when the loop section 725 is snuggly fit to the front and the back of front cover 705, and the first retaining device 730 and the second retaining device 740 are firmly secured against the cover of the book 700. Marking means 735 may then be placed between two pages of the plurality of pages 710.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A bookmark for use with a book having at least a bookmark mounting portion and at least two pages, said bookmark comprising:
a length of flexible material formed into a loop, said length of flexible material having a first end with a first leg extending therefrom and a second end having a second leg extending therefrom;
an adjuster for positioning about said first leg and said second leg and sized for frictional movement of at least one of said first leg and said second leg through said adjuster to move said loop between a first position sized to snuggly engage said bookmark mounting portion and a second position larger than said first position for disengaging said loop from said bookmark mounting portion; and
a marking means having a lead formed from said one of said first leg and said second leg extending away from said loop and said adjuster, said lead being sized in length to position one of said first end and said second end of aid first leg and said second leg between said two pages, and said marking means having a marker attached to one of said first end and said second end for marking, said marking means being attached to one of said first end and said second end of said length of flexible material.

2. A bookmark for marking a page in a book having pages, said bookmark comprising:
a line having a loop portion having a first leg and a second leg, said loop portion being sized to extend around a portion of said book having pages, and said line having a marking section attached to said loop portion that extends away from said loop portion and sized in length for positioning a distal end thereof between two pages of said book with said loop portion installed on said portion of said book;
a retaining device for holding said first leg and said second leg relative to each other to form said loop portion, said retaining device being configured to allow relative movement of at least said first leg relative to said second leg; and
a marking means for marking said page in said book, said marking means being secured to said distal end of said marking section.

3. A bookmark for marking a page in a book having pages, said bookmark comprising:
a line having a loop portion having a first leg and a second leg, said loop portion being sized to extend around a portion of said book having pages, and said line having a first marking section and a second marking section attached to said loop portion that extends away from said loop portion, said first marking section sized in length for positioning a distal end thereof between two pages of said book with said loop portion installed on said portion of said book;
a securing member for holding said first leg and said second leg to form said loop portion, said retaining device being configured to allow movement of said first leg or said second leg relative to said securing member; and
a marking means for marking said page in said book, said marking means being secured to said distal end of said first marking section.

4. The bookmark of claim 3, wherein said second marking section is sized in length for positioning a distal end thereof between two pages of said book.

5. The bookmark of claim 4, wherein said marking means is secured to said distal end of said second marking section.

6. The bookmark of claim 3, wherein said securing member holds said first leg and said second leg relative to each other to form said loop portion, and wherein said securing member is configured to allow relative movement of at least said first leg relative to said second leg.

7. The bookmark of claim 3, wherein said marking means is a substantially flat member.

8. The bookmark of claim 7, wherein said substantially flat member is manufactured from a material selected from a group consisting of metal, plastic, wood and jewels.

9. The bookmark of claim 8, wherein said substantially flat member is a picture holder.

10. The bookmark of claim 8, wherein said substantially flat member is a charm.

11. The bookmark of claim 8, wherein said substantially flat member is engraveable.

12. The bookmark of claim 3, wherein said securing member is configured to provide a tension in said loop portion.

13. The bookmark of claim 12, wherein said securing member is engaged at a selected position on said first leg and said second leg to removably secure said loop portion to said portion of said book.

14. The bookmark of claim 13, wherein said securing member is configured to slidably engage said first leg and said second leg using a coefficient of friction.

15. The bookmark of claim 14, wherein said securing member has an aperture disposed therein for receiving said first leg and said second leg, said aperture being sized to frictionally engage said first leg and said second leg at said selected position.

16. The bookmark of claim 15, wherein said portion of said book is a spine of said book.

17. The bookmark of claim 15, wherein said portion of said book is a cover of said book.

18. The bookmark of claim 15, wherein said portion of said book is a plurality of pages of said book.

19. The bookmark of claim 3, wherein said line is a length of rope.

20. The bookmark of claim 3, wherein said line is a length of ribbon.

21. The bookmark of claim 3, wherein said line is a length of cord.

22. A bookmark for marking a page in a book, said bookmark comprising:
a line having a first end and a second end and a length therebetween, a first portion of said length forming a loop section having a first leg and a second leg, said loop section sized to extend around a portion of said book, and a second portion of said length forming a first marking section;
a securing member for engaging said first leg and said second leg to form said loop section, said securing member being configured to allow movement of at least said first leg relative to said second leg and said securing member; and
a place marker for marking said page in said book, said place marker attached to said first marking section.

23. The bookmark of claim 22, wherein said marking section is sized in length for positioning a distal end thereof between two pages of said book with said loop portion installed on said portion of said book.

24. The bookmark of claim 23, wherein a third portion of said length forms a second marking section, wherein said second marking section is sized in length for positioning a distal end thereof between two pages of said book with said loop portion installed on said portion of said book.

25. The bookmark of claim 24, wherein said second marking section is attached to said place marker.

26. A method of marking a page in a book having pages, said method comprising:
providing line having a loop portion having a first leg and a second leg, said line having a marking section attached to said loop portion that extends away from said loop portion and sized in length for positioning a distal end thereof between two pages of said book;
providing a retaining device for holding said first leg and said second leg relative to each other to form said loop portion, said retaining device being configured to allow relative movement of at least said first leg relative to said second leg;
engaging said retaining device to said first leg and said second leg with said loop portion installed on said portion of said book;
providing a marking means for marking said page in said book; and
securing said marking means to said distal end of said marking section.

27. The method of claim 26, further comprising engaging the retaining device to frictionally engage said first leg and said second leg to removably secure said loop portion to said section of said book.

28. The method of claim 27, wherein said section of said book is a spine of said book.

29. The method of claim 27, wherein said section of said book is a cover of said book.

30. The method of claim 27, wherein said section of said book is a plurality of pages of said book.
